(19) United States
(12) Patent Application Publication
(10) Pub. No.: US 2007/0198244 A1
(43) Pub. Date: Aug. 23, 2007

(54) Emulation of a device protocol

(76) Inventors: James M. King, Ft. Collins, CO (US); David Pinedo, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/343,791

(22) Filed: Jan. 31, 2006

(51) Int. Cl. G06F 9/455

(52) U.S. Cl. 703/27; 719/321

(57) ABSTRACT

A second system that comprises a receiver and an emulator. The receiver receives a packet from a first system on which a first operating system executes. The packet comprises information associated with a device driver call that comports with a device protocol of the first system and that originated on the first system. The emulator converts the packet's information associated with the device driver to a device protocol of a second operating system. The second operating system is different than the first operating system.

### BACKGROUND

Peripherally connected devices, such as universal serial bus (USB) devices, are accessed by the computer to which they are directly connected. In some situations, it is desirable to access, from a first computer, a device operatively coupled to a second computer. A further complication is when the two computers run disparate operating systems.

### BRIEF DESCRIPTION OF THE DRAWINGS

For a detailed description of exemplary embodiments of the invention, reference will now be made to the accompanying drawings in which:

FIG. 1 shows a computing system in accordance with embodiments of the invention;

FIG. 2 shows a block diagram of a system in accordance with embodiments of the invention; and

FIG. 3 shows an illustrative method embodiment of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. The term “system” refers to a collection of two or more components (hardware, software, or a combination thereof). A system may refer to a computer, a subsystem of a computer, a collection of two or more computers, etc.

### DETAILED DESCRIPTION

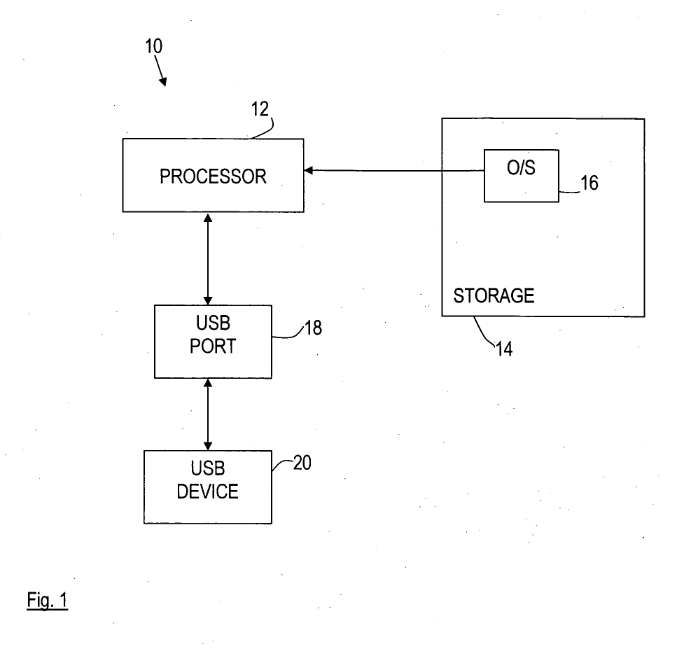

Referring to FIG. 1, a computing system 10 is shown in accordance with at least one embodiment of the invention. As shown, computing system 10 comprises a processor 12, storage medium 14, and a device port 18. A detachable device 20 can be connected to the system 10 via the device port 18. In at least one embodiment of the invention, the device port 18 and device 20 are provided in accordance with the USB protocol. As such, the port 18 and device 20 are referred to below as a USB port and a USB device, respectively. In other embodiments, the device 20 and associated port are provided in accordance with other protocols.

The storage medium 14 comprises volatile memory and/or non-volatile storage. Volatile memory comprises random access memory (RAM) and non-volatile storage comprises read only memory, a hard disk, a compact disc read-only memory (CD ROM), etc. An operating system (O/S) 16 is provided on storage medium 14. The O/S 16 is executed by the processor 12. The O/S may be any suitable version of the WINDOWS suite of operating systems, a LINUX O/S, etc. The embodiments described below may be implemented on a computing system such as that shown in FIG. 1.

Embodiments of the invention enable a USB device to be attached (e.g., directly connected) to a system having a particular operating system in such a way that, to a different system having a different operating system, the device seems to be actually attached to such other different system. That is, the system to which the device is not attached operates as if the device was attached to that system. For example, a USB device can be connected to a system executing the LINUX operating system and yet the device appears to another system on which, for example, a WINDOWS operating system executes that the device is actually connected to the WINDOWS-based system. The following description explains an embodiment in which a WINDOWS operating system executes on one system while another system, to which the USB device actually connects, executes LINUX. In other embodiments, other operating systems executes on the systems.

The WINDOWS operating system implements a USB protocol for accessing a USB device connected to a system on which the WINDOWS operating system executes, while a LINUX operating system implements a different USB protocol for accessing a USB device connected to a LINUX-based system. The two USB protocols differ, for example, in terms of the commands each system uses to access a USB device. Device drivers are implemented in each type of system to receive higher-level operating system calls and react appropriately to access the target USB device. Embodiments of the invention include a WINDOWS USB protocol request being intercepted in a WINDOWS-based system and transmitted by the WINDOWS-based system to a LINUX-based system on which the target USB device actually resides. On the LINUX-based system, the received WINDOWS USB protocol is converted to a LINUX USB protocol, suitable to perform the request, and injected into the LINUX operating system.

The WINDOWS USB protocol comports with the WINDOWS Driver Model (WDM). The WDM is a high-level interface for vendor-specific device drivers to integrate into the WINDOWS suite of operating systems. The LINUX USB interface is closer to a hardware abstraction than the WINDOWS USB interface and, consequently, USB drivers are modeled at a higher level of abstraction on WINDOWS systems than the equivalent model on the LINUX family of operating systems.

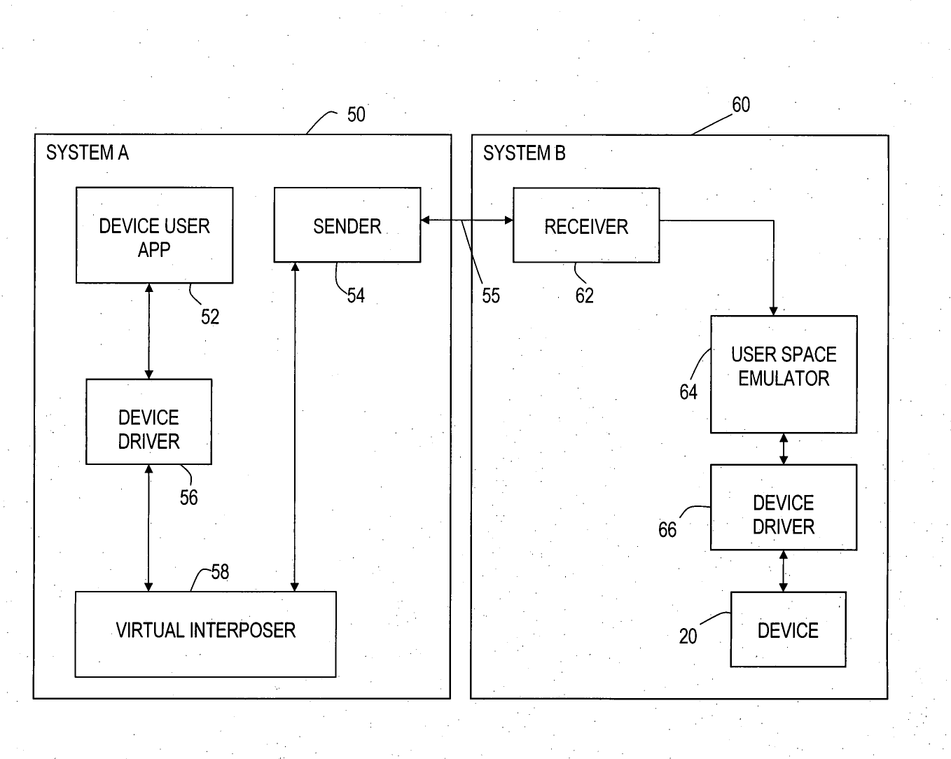

FIG. 2 shows two systems 50 and 60 that can communicate with one another. System 50 is referred to as “system A,” while system 60 is referred to as “system B.” System A runs a WINDOWS operating system, while system B runs a LINUX operating system. Each of the systems A and B can be implemented in the form of a computing system such as that shown in FIG. 1. System B comprises a USB port as shown in FIG. 1 to which a USB device can be connected. System A may or may not have a USB port.

System A comprises a device user application 52, a sender 54, a device driver 56, and a virtual interposer 58. The device user application 52, a sender 54, a device driver 56, and a virtual interposer 58 are implemented in software in some embodiments, but in other embodiments, one or more of the device user application 52, a sender 54, a device driver 56, and a virtual interposer 58 may be implemented in hardware or a combination of hardware and software.

The device user application 52 on system A is a user-space application that accesses an associated device. In the example of FIG. 2, the device to be accessed by the device user application 52 comprises device 20 physically connected to system B.

The device driver 56 receives “calls” from the device user application 52 and responds by issuing calls intended for one or more lower level drivers, which may or may not be present in system A. The virtual interposer 58 intercepts such calls intended for the lower level drivers, forms one or more packets containing the calls, or at least information associated with the intercepted calls, and provides such packets to the sender 54. The purpose of the virtual interposer 58 is to intercept calls from the device driver 56 intended for the device 20, and not allow such calls to proceed to a lower level driver in the WINDOWS operating system. Virtual interposer 58 converts the intercepted call into a packet of data suitable for transmission over a network link 55. The packet formed by virtual interposer 58 includes the call, or at least information associated with the intercepted call, as a data payload associated with the packet. The sender 54 sends the packet across network link 55 (e.g., the internet) to the receiver 62 in system B on which the LINUX operating system executes.

System B comprises a receiver 62, an emulator 64, and a device driver 66. The receiver 62 receives the packet and extracts the WINDOWS USB protocol call, or call-related information, from the received packet and provides the extracted WINDOWS USB call to system B's emulator 64. In at least some embodiments, the emulator is implemented in software. In some such software embodiments of the emulator 64, a portion of the emulator is implemented in system B's “user space” and another portion of the emulator is implemented in system's “kernel space.” The emulator 64 emulates the WINDOWS USB protocol on system B, which executes a non-WINDOWS operating system (e.g., LINUX). Once the WINDOWS USB protocol is emulated on system. B, the emulator 64 provides a native LINUX USB call to a device driver 66 which,. in turn, accesses USB device 20.

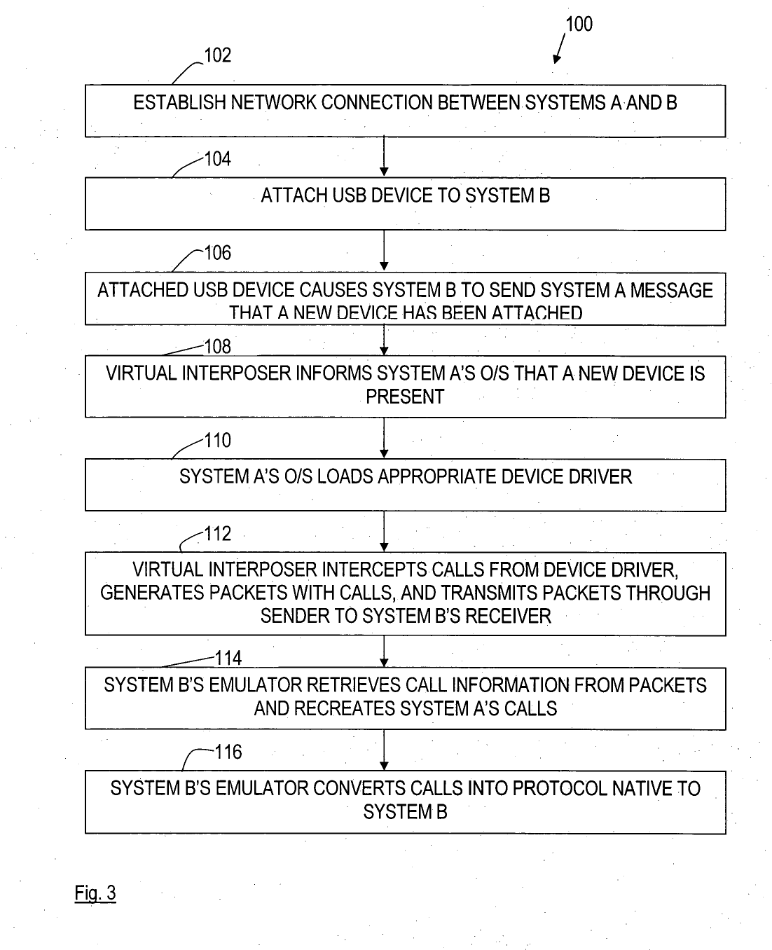

FIG. 3 illustrates a method 100 in which the WINDOWS USB protocol is converted to the LINUX USB protocol. The various actions depicted in FIG. 3 are illustrative of some, but not all embodiments of the invention. Other embodiments may vary from that shown in FIG. 3 in the order of the actions. Further, some actions may be combined together in a single action. Further still, not all actions listed in FIG. 3 may be present in other embodiments.

At 102, a network connection is established from the WINDOWS operating system (system A) to the recipient LINUX operating system (system B). Upon establishing the connection, or at an earlier point in time, the virtual interposer 58 is installed on system A and the LINUX emulator 64 is installed on system B.

At 104, the USB device 20 is attached to system B. Connection of USB device 20 to system B causes system B to send a message to system A that a new device has been attached (106). The message causes the virtual interposer 58 to inform system A's operating system (e.g., WINDOWS) that a new USB device is present (108). Although the USB device 20 has been attached to system B, system A's operating system is simply made aware of the attachment of the device in accordance with how a WINDOWS operating system is made aware of the attachment of any USB device. As a result, the WINDOWS operating system running on system A is informed of the attachment of a USB device, but not that the device was actually attached to another computer. Thus, as far as system A is concerned, USB device 20 is attached to system A.

At 110, system A's operating system loads the device driver 56, to the extent driver 56 is not already loaded. The USB user application 52 then begins attempting to access the USB device (e.g., reads, writes, etc.). The operating system on system A reacts to the attempts of the application 52 to access the USB device 20, which as far as system A is concerned, is attached to system A, by making calls through the device driver 56 to the lower level drivers (which may or may not be present). At 112, the virtual interposer 58 intercepts such calls, generates packets with the calls and, through sender 54, transmits the packets to system B's receiver 62. At 114, once the packet of data is received by system B, emulator 64 extracts the WINDOWS USB call information and, at 116, converts such calls into a native LINUX operating system USB protocol request.

Several examples of how a WINDOWS USB request is converted into equivalent LINUX USB requests are now described. In a first example, the WINDOWS USB URB_FUNCTION_GET_DESCRIPTOR command, which will be emulated on system B, requests descriptor information from the USB device. The process of translating the URB_FUNCTION_GET_DESCRIPTOR call involves:
determine the target USB device;
determine the direction of the request, either a read or write;
determine the recipient of the request, either a DEVICE, an INTERFACE, or an ENDPOINT;
determine the type of descriptor;
determine the type of the request which include any of DEVICE, CONFIGURATION, STRING, INTERFACE, ENDPOINT, DEVICE QUALIFIER, SPEED CONFIGURATION, or INTERFACE POWER.
convert some or all of the aforementioned information to the appropriate LINUX USB protocol structures and perform the usb_control_msg( ) request to the LINUX operating system that will connect to the target device, and perform either a read or write to the target device using an appropriate request type; and
retrieve the response from the LINUX usb_control_msg() request and. convert the response to the WINDOWS USB protocol structure.

Once the response to the request is converted back into a WINDOWS USB protocol structure, the WINDOWS protocol structure is transmitted back to system A by way of a packet as previously described. The virtual interposer 58 returns the result to device driver 56.

A second example of emulating a WINDOWS USB protocol on a LINUX-based system involves converting the URB_FUNCTION_GET_CONFIGURATION WINDOWS USB request to obtain a USB device's configuration information. The process of translating the URB_FUNCTION_GET_DESCRIPTOR comprises:
determine the target USB device;
determine the direction of the request, either a read or write;
determine the recipient of the request, either a DEVICE, an INTERFACE, or an ENDPOINT;
determine the type of descriptor;
determine the type of the request which include any of DEVICE, CONFIGURATION, STRING, INTERFACE, ENDPOINT, DEVICE QUALIFIER, SPEED CONFIGURATION, or INTERFACE POWER.
perform a sequence of LINUX USB protocol requests to gather all the data from the USB device to reply to the request. This process may include multiple calls to, for example, the device configurations, the configuration interfaces and each interface endpoint. These calls are performed on system B using the usb_control_msg( ) on the LINUX operating system;
retrieve the responses from the LINUX usb_control_msg( ) requests and convert this information to the proper WINDOWS USB protocol structure.

Once the response information has been converted into the proper format for the WINDOWS USB protocol structure, the information is transmitted back to system A. The virtual interposer 58 then returns the results to the device driver 56.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
a first system generating a call intended for a device driver that, if installed, is installed on the first system, a first operating system running on said first system, and said call intended to access a device;
intercepting said call;
forming a packet with said call or information associated with said intercepted call;
sending said packet to a second system on which a second operating system runs, said second operating system being different than the first operating system; and
on the second system, converting said call to a protocol that comports with said second operating system.

2. The method of claim 1 further comprising, when the device is connected to the second system, sending a message from the second system to the first system that a new device is present.

3. The method of claim 2 further comprising the first system loading a device driver upon receiving the message that a new device is present.

4. The method of claim 1 wherein the device is connected to the second system and the method further comprises receiving a response from the device connected to the second system and, in the second system converting the response to a protocol compatible with the first operating system.

5. A storage medium comprising software that, when executed by a second system on which a second operating system executes, causes the second system to:
receive a packet that contains information associated with a device driver call that comports with a first device protocol and that originated on a first system on which a first operating system executes, said second operating system being different than the first operating system; and
emulate the first device protocol to perform an action specified by said call.

6. The storage medium of claim 5 wherein said software causes said second system to receive information in response to said call and convert said information to the first device protocol.

7. The storage medium of claim 5 wherein said software causes said second system to retrieve said call from said packet, said retrieved call being in a format that comports with said first device protocol.

8. The storage medium of claim 7 wherein said software emulates the first device protocol by converting said retrieved call to at least one message that comports with a device protocol of said second operating system.

9. A second system, comprising:
a receiver that receives a packet from a first system on which a first operating system executes, said packet comprising information associated with a device driver call that comports with a device protocol of said first system and that originated on said first system; and
an emulator that converts the packet's information associated with the device driver to a device protocol of a second operating system, said second operating system being different than the first operating system.

10. The system of claim 9 wherein said emulator, at least in part, enables said first system to access a device connected to said second system with said first system operating as if the device was connected to the first system.
